(19) United States
(12) Patent Application Publication
(10) Pub. No.: US 2011/0146452 A1
(43) Pub. Date: Jun. 23, 2011

(54) Gas Cap Tool

(76) Inventor: William Maegli, Milwaukee, WI (US)

(21) Appl. No.: 12/640,914

(22) Filed: Dec. 17, 2009

(51) Int. Cl. B67B 7/14

(52) U.S. Cl. 81/3.09; 81/3.4

(57) ABSTRACT

This tool aids a user remove a twist cap. This tool provides an extension to a tight area while providing the user with a solid grip to twist a gas cap on or off. This tool is best suited for removing gas caps from automobiles.

### BACKGROUND

Most gasoline stations provide self-service only or a combination of self-service and full service to their customers. However, even those with the combination of services normally have the full service being a few cents more a gallon of self-service stations. Thereby, most people opt for the self-service pumps, even when there is full service available.

The cars that are on the road today normally have access to the gas caps by one of the rear quarter panels of the vehicle. In order to access the gas cap, a door must be opened in order to access the gas cap. Because of the narrow opening that the door defines it can be difficult to twist off the cap. Part of the problem is the government requiring the proper sealing of evaporated fumes from the gas tank access port. Thereby, automotive manufacturers have designed gas caps that have a resistive click when they are tightened. This additive resistance makes the gas cap more difficult to remove, in order to access the gas tank. Anyone having a problem with their hands, such as arthritis, has a greater frustration in twisting the gas cap to remove it.

Previous devices and patents have tried to solve this problem. However, these devices and patents are very cumbersome and not necessarily user-friendly. Many of the devices listed will not work with gas caps that are bounded together to the door access.

### SUMMARY OF THE INVENTION

This invention provides a light, portable, easy to use and economical way to remove a gas cap. This invention is easily stored in a glove compartment until needed. The device is designed to easily find the tab that is on most gas caps and provides an easy twisting or torque to remove the gas cap. This invention does not require any special mounting in order to use it.

### DESCRIPTION OF THE DRAWINGS

FIG. 1 illustrates the side view of the invention, if the invention was resting on a flat surface;

FIG. 2 illustrates a 90° side view from FIG. 1;

FIG. 3 shows a bottom view of the entire invention, illustrating the twisting motion of the invention;

FIG. 4 shows a subset of FIG. 3 by focusing on the gripping portion of the invention.

FIG. 5 illustrates the alignment of attaching the invention to a gas cap.

### DESCRIPTION OF THE INVENTION

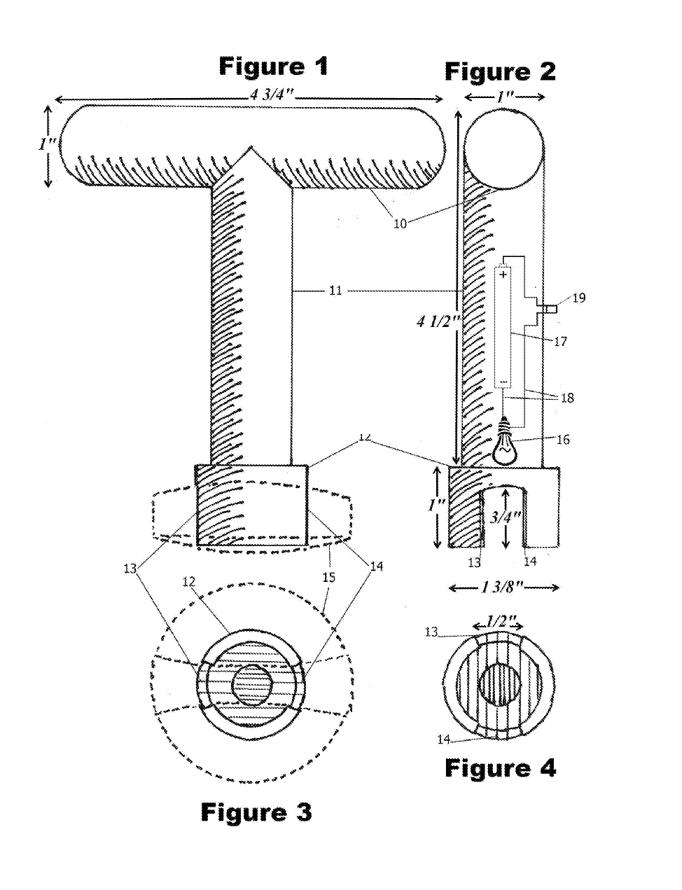

Referring to the drawings, FIG. 1 and FIG. 2 illustrates the invention showing a handle 10, a stem 11, a head 12. FIG. 2 further shows directly a left beveled notch 13 and because of the removal of material indirectly shows the right beveled notch 14. FIGS. 3 and 4 shows the left beveled notch 13 and the right beveled notch 14 distinctly. FIGS. 1, 3 and 5 shows the tool in contact with the gas cap 15.

Optionally contained within the bottom portion of the stem 11 is an illuminating device 16 such as an LED or a small light bulb. The illuminating device 16 is powered by a power source 17 and connected with electrical wire 18 and a switch 19.

In its simplest form, the invention is a one-piece device, formed out of material that is hard and durable such as (but not limited to) plastic or lightweight metal such as aluminum. The handle 10 and is directly attached to the top part of the stem 11 either by glue or directly attached as a one-piece molded device. The head 12 is similarly attached to the bottom of the stem 11 either by glue or as part of the one-piece molded device. The head 12 is aligned such that the center line of the handle 10 and the center line determined by the centers of the left beveled notch 13 and right beveled notch 14 are essentially parallel. This can best be seen in FIG. 2.

The handle 10 is designed to be easily gripped by a human hand. Thereby, the handle 10 is approximately 4¾ inches long and approximately 1 inch in diameter. The handle 10 is similar to a cylinder with cut off edges or with rounded edges as shown in FIG. 1. The handle 10 can be of any shape (square, triangular, etc.), ideally for this invention the shape is circular. The handle 10 may be a solid core or maybe hollow as long as the remaining material in the handle 10 can tolerate the stress of the twisting of the gas cap 15.

The stem 11 is similar in design to the handle 10. The stem 11 can be as long as necessary to access a gas cap 15. In the automobiles on the road today, the preferred length is approximately 4½ inches. However, the designed length of the stem 11 is determined by how deep the gas cap 15 is away from the surface of a car. The diameter is approximately 1 inch. The stem 11 can be of any shape (square, triangular, etc.), ideally for this invention the shape is circular. The handle 10 may be a solid core or maybe hollow as long as the remaining material in the stem 11 can tolerate the stress of the twisting of the gas cap 15.

The head 12 is attached to the lower portion of the stem 11. The head 12 can be a distinct piece or can be incorporated as part of the stem 11. The head 12 can be designed as large or small as necessary, based on the gas cap 15 that needs to be twisted. For automobiles are on the road today, the preferred head 12 is approximately 1 inch high, and 1⅜ inch in diameter. The head 12 can be of any shape (square, triangular, etc.), ideally for this invention, the shape is cylindrical. The head 12 may be a solid core or maybe hollow (similar to a thick walled can) as long as the remaining material in the head 12 can tolerate the stress of the twisting of the gas cap 15. If the head 12 is solid, then the left beveled notch 13 and the right beveled notch 14 would make the head 12 as viewed from the bottom as if it were a channel. The attachment of the head 12 to the stem 11 may be done by either glue, encompassed in a body molding or by having the stem 11 and ripping device threaded such that the gripping device can be screwed on and locked to the stem 11.

The left beveled notch 13 and the right beveled notch 14 are normally equivalent in size and shape. The size and shape of the beveled notches is designed such that they are slightly larger than the tab they are to grab. For gas caps 15 that are in today's cars, the preferred height of the left beveled notch 13 and the right beveled notch 14 is ¾ inch high. The width of the left beveled notch 13 and the right beveled notch 14 is approximately ½ inch.

The shape of the left beveled notch 13 and the right beveled notch 14 is similar to a rectangle, the preferred design is having the bottom of each rectangle is slightly larger than the top in order to provide an easier guide to attaching this tool to the gas cap 15, as the invention finishes its alignment with the gas cap 15. However the left and right edges of the left beveled notch 13 and the right beveled notch 14 (rectangle) may be perpendicular to the bottom edge of the head 12. The top boundary of the left beveled notch 13 and the right beveled notch 14 (rectangle) may either be a straight edge or slightly curved.

In a more sophisticated version of the invention, the invention may contain a power source 17 such as a battery, an illuminating device 16 such as a small light bulb or an LED, electrical wire 18 and a switch 19. In this configuration, the illuminating device 16 is mounted into the bottom portion of the stem 11 or the top portion of the head 12. The power source 17 may be stored within a hollow stem 11 and/or in the handle 10. If the power source 17 is in the stem 11, the access to replace the power source 17 can be done by either removing the handle 10 and or removing the head 12. If the power source is in the handle 10, then the left and right ends of the handle 10 are created such that the left and right ends of the handle 10 have easy removing and securing methods (i.e. a screwing mechanism). The power source 17 would be connected to the illuminating device 16 via wires 18 or a metallic lead painted shell within the handle 10 and the stem 11. The illuminating device 16 would be turned on by either a switch 19 located on the invention or may be made through sophisticated contact device when attached to a gas cap 15.

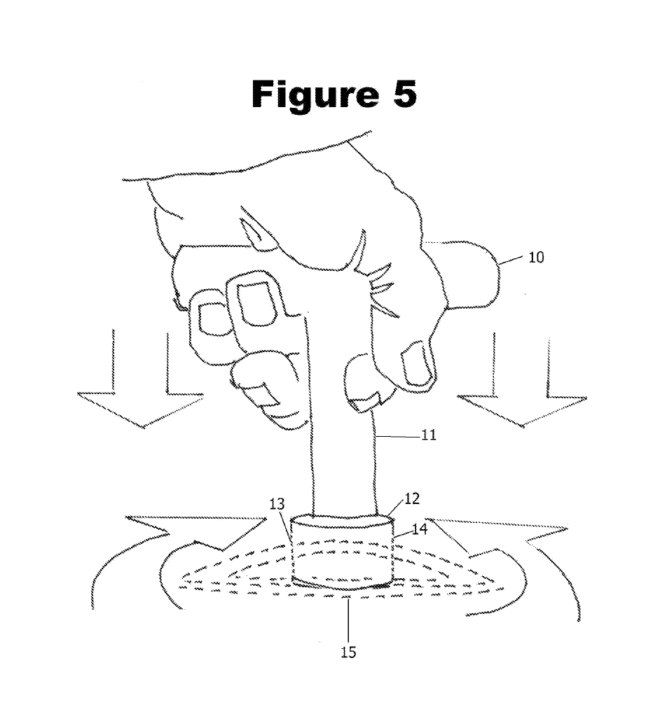

To use the tool, as shown in FIG. 5, a human hand grabs the handle 10 and visually aligns the left beveled notch 13 and the right beveled notch 14 such that it will surround the vertical tab of the gas cap 15. The user then twists the handle 10 (normally in a counterclockwise direction to remove) to remove the gas cap 15. The invention may also be used to tighten the gas cap 15 (normally in a clockwise direction to tighten).

I claim:

1. A tool for turning a gas cap comprising:
a. a handle;
b. a stem attached to the handle;
c. a head attached to the stem comprising:
i. a left notch having a center,
ii. a right notch having a center such that both centers are directly opposite each other.

2. The tool for turning a gas cap of claim 1 comprising:
a. a power source;
b. an illuminating device;
c. a switch;
d. electrical conducting material that connects the power source, the switch and the illuminating device in series completing a circuit.

3. The tool for turning a gas cap of claim 2, where the power source is contained within the handle.

4. The tool for turning a gas cap of claim 2, where the power source is contained within the stem.

5. The tool for turning a gas cap of claim 2, where the power source is contained within both the handle and the stem.

6. The tool for turning a gas cap of claim 2, where the illuminating device is contained in the bottom of the stem.

7. The tool for turning a gas cap of claim 2, where the illuminating device is contained within the head.

8. The tool for turning a gas cap of claim 2, where the power source, the illuminating device, the switch and the electrical conducting material is located in the stem.

9. The tool for turning a gas cap of claim 2, where the illuminating device is located in the stem.

10. The tool for turning a gas cap of claim 9, where the power source, the switch and the electrical conducting material are located in the stem.

11. The tool for turning a gas cap of claim 9, where the power source and the switch are located in the handle and the electrical conducting material is located both in the stem and the handle.

12. The tool for turning a gas cap of claim 1, where the head is solid and the combination of the left notch and the right notch form a channel.

13. A method for twisting a gas cap using a gas cap tool comprising the steps of:
a. grabbing a handle of the gas cap tool;
b. align notches at the bottom of the gas cap tool to a tab of a gas cap;
c. secure the bottom of the gas cap tool to the tab of the gas cap;
d. using the handle, twist the cap.

14. The method for twisting a gas cap of claim 13, such that the first step is to flip a switch on the gas cap tool which will provide light in the bottom of the gas cap tool and the gas cap.
